(19) United States
(12) Patent Application Publication
(10) Pub. No.: US 2019/0220669 A1
(43) Pub. Date: Jul. 18, 2019

(54) CONTENT PRESENTATION BASED ON VIDEO INTERACTION

(71) Applicant: International Business Machines Corporation, Armonk, NY (US)

(72) Inventors: Eric Gross, Austin, TX (US); Thomas Boop, Austin, TX (US); Kevin Brewer, Austin, TX (US); Priscila Cortez, Travis, TX (US)

(21) Appl. No.: 15/869,688

(22) Filed: Jan. 12, 2018

(51) Int. Cl. G06K 9/00; H04N 21/466

(52) U.S. Cl. CPC G06K 9/00744; H04N 21/4665; G06K 9/00758

(57) ABSTRACT

Methods and systems for identifying content to be outputted during an output of a video are described. A processor may identify a section in a video image of the video. The processor may assign a classification type to the section. The processor may output the video including the set of video images. The processor may detect an interaction with the section during the output of the video. The processor may identify, in response to detecting the interaction, content associated with the classification type assigned to the section in the video image. The processor may output the identified content during the output of the video.

The present application relates generally to computers, and computer applications, and more particularly to computer-implemented methods and systems in content distribution and content identification.

### BACKGROUND

Content providers may output multimedia content, such as a video, to a user. Content providers may embed content (e.g., advertisements, messages, images, hyperlinks, etc.) at one or more instances during output of the video. In some examples, metadata and/or cookies may be used to track activities of the user in order to identify promotional or other content to be embedded into the video. Identifying appropriate content to be outputted during an output of the video may improve a user experience of the user when viewing the outputted video.

### SUMMARY

In some examples, methods for identifying content to be outputted during an output of a video are generally described. The methods may include identifying, by a processor, a section in a video image among a set of video images of the video. The methods may further include assigning, by the processor, a classification type to the section. The methods may further include outputting, by the processor, the video, where outputting the video may includes outputting the set of video images. The methods may further include detecting, by the processor, an interaction with the section during the output of the video. The methods may further include identifying, by the processor, in response to detecting the interaction, content associated with the classification type assigned to the section in the video image. The methods may further include outputting, by the processor, the identified content during the output of the video.

In some examples, systems effective to identify content to be outputted during an output of a video are generally described. The systems may include a memory configured to store video data associated with the video, where the video data may include a set of video images. The system may further include a processor configured to be in communication with the memory. The system may further include a matching device configured to be in communication with the memory and the processor. The matching device may be configured to identify a section in a video image among a set of video images of the video data. The matching device may be further configured to assign a classification type to the section. The processor may be configured to output the video, where output of the video includes output of the set of video images. The processor may be further configured to detect an interaction with the section during the output of the video. The matching device may be further configured to identify, in response to the interaction, content associated with the classification type assigned to the section in the video image. The processor may be further configured to output the identified content during the output of the video.

In some examples, computer program products for identifying content to be outputted during an output of a video are generally described. The computer program product may include a computer readable storage medium having program instructions embodied therewith. The program instructions may be executable by a device to cause the device to identify a section in a video image among a set of video images of the video. The program instructions may be further executable by a device to cause the device to assign a classification type to the section. The program instructions may be further executable by a device to cause the device to output the video, where output of the video may include output of the set of video images. The program instructions may be further executable by a device to cause the device to detect an interaction with the section during the output of the video. The program instructions may be further executable by a device to cause the device to identify, in response to detecting the interaction, content associated with the classification type assigned to the section in the video image. The program instructions may be further executable by a device to cause the device to output the identified content during the output of the video.

### BRIEF DESCRIPTION OF THE DRAWINGS

FIG. 1 illustrates an example computer system that can be utilized to implement content presentation based on video interaction.

FIG. 2 illustrates the example system of FIG. 1 with additional details relating to content presentation based on video interaction.

FIG. 3 illustrates the example system of FIG. 1 with additional details relating to content presentation based on video interaction.

FIG. 4 illustrates a flow diagram for an example process to implement content presentation based on video interaction.

FIG. 5 is an exemplary block diagram of a computer system in which processes involved in the system, method, and computer program product described herein may be implemented.

### DETAILED DESCRIPTION

Briefly stated, methods and systems for identifying content to be outputted during an output of a video are described. A processor may identify a section in a video image of the video. The processor may assign a classification type to the section. The processor may output the video including the set of video images. The processor may detect an interaction with the section during the output of the video. The processor may identify, in response to detecting the interaction, content associated with the classification type assigned to the section in the video image. The processor may output the identified content during the output of the video data.

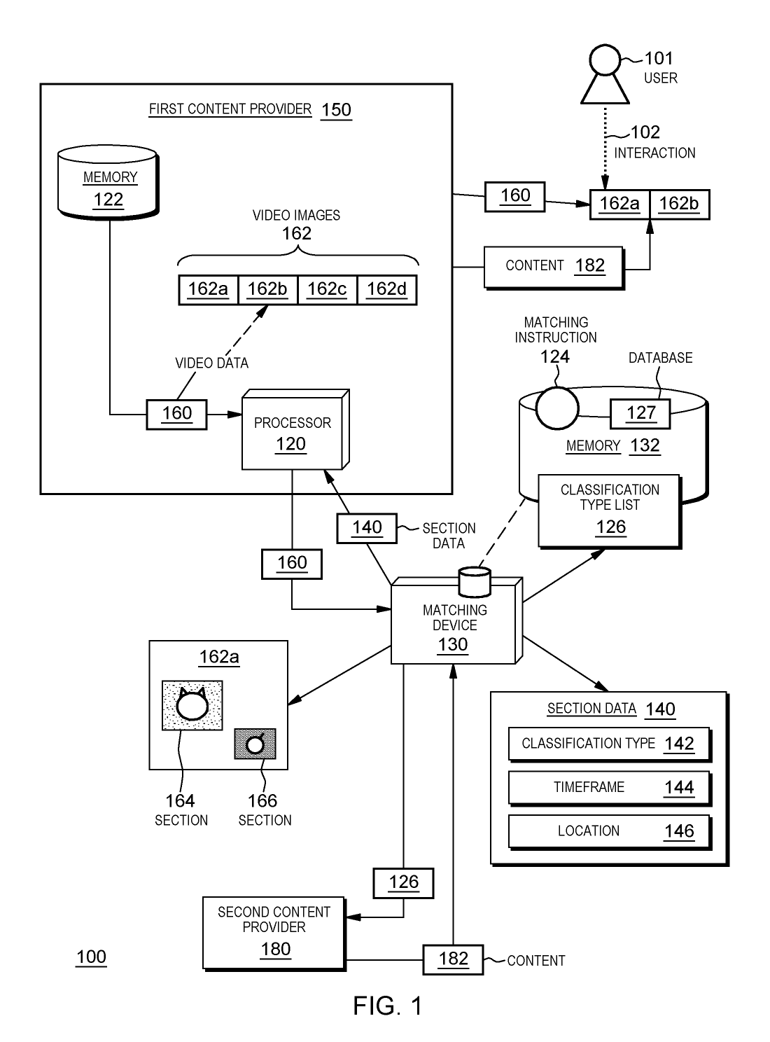

FIG. 1 illustrates an example computer system 100 that can be utilized to implement content presentation based on video interaction, arranged in accordance with at least some embodiments described herein. In some examples, system 100 may be a computer system, and may be implemented by a matching device 130, a first content provider 150, and a second content provider 180. In some examples, matching device 130 may be a part of first content provider 150. First content provider 150 may include a processor 120 and a memory 122. Matching device 130 may include a memory 132. Processor 120 may be configured to be in communication with memory 122 and matching device 130. Matching device 130 may be configured to be in communication with memory 132 and second content provider 180.

In some examples, processor 120 and matching device 130 may each be hardware components or hardware modules of system 100. In some examples, matching device 130 may be a hardware processor different from processor 120. In some examples, matching device 130 may be a hardware component, or a hardware module, of processor 120. In some examples, processor 120 may be a central processing unit of a computer device. In some examples, processor 120 may control operations of matching device 130. In some examples, matching device 130 may include electronic components, such as integrated circuits. In some examples, processor 120 may be configured to run an operating system that includes instructions to manage matching device 130, memory 122, and memory 132. Matching device 130 may further include one or more components, such as graphics processors, configured to perform image processing analysis on image data and/or video data.

First content provider 150 may be associated with a content provider, such as a platform to playback videos (e.g., YOUTUBE) through a network (e.g., Internet). In some examples, second content provider 180 may be associated with one or more entities that may desire to promote products or services. In some examples, second content provider 180 may be a platform to playback videos, output images, output links to web pages, etc. It is not required that second content provider 180 be associated with an entity that promotes products or services. In other examples, second content provider 180 may be associated with one or more entities that provide information on one or more topics. In some examples, second content provider 180 may be an online encyclopedia (e.g., Wikipedia), a website for a magazine (e.g., Consumer Reports) or a news organization, or other platform not having a primary purpose of promoting particular products or services. In some examples, matching device 130 may be a part of first content provider 150 and may facilitate playback of videos to one or more user devices. In some examples, first content provider 150 and second content provider 180 may be configured to be in communication through a network, such as the Internet.

First content provider 150 may receive one or more pieces of video data, where the video data may correspond to videos being uploaded by one or more users to content provider domain. Each video data, when rendered, may be outputted as a video. Each video data may include a set of video images. Processor 120 of first content provider 150 may store video data received from users in memory 122. Furthermore, upon receipt of each piece of video data, processor 120 may send the received video data to matching device 130 in order for matching device 130 to match video images among the received video data with one or more pieces of content, where the content may include, but not limited to, at least one of an advertisement, a hyperlink, a message, an image, and a video, etc. (further described below).

Memory 132 of matching device 130 may be configured to store a matching instruction 124. Matching instruction 124 may include one or more set of instructions to facilitate implementation of system 100. Matching instruction 124 may include instructions relating to image processing techniques, such as object identification, edge detection, etc. In some examples, memory 122 and memory 132 may each be a part of a main memory.

In an example shown in FIG. 1, a piece of video data 160 may be received by processor 120, and processor 120 may send video data 160 to matching device 130. Video data 160 may include a set of video images 162 (including 162a, 162b), which may be grouped as frames, where each video image may be a still image. Matching device 130 may analyze one or more video images among video images 162. In some examples, matching device 130 may analyze all video images among video images 162. In some examples, matching device 130 may analyze a subset of video images 162.

Focusing on video image 162a as an example, matching device 130 may execute matching instructions 124 to identify one or more sections of video image 162a. Matching device 130 may execute image processing techniques related to object identification to identify sections 164, 166 in video image 162a. For example, if video image 162a includes a cat and an apple, matching device 130 may identify a portion of video image 162a that may be surrounding the cat (section 164) and another portion of video image 162a that may be surrounding the apple (section 166) using image processing techniques. Sections 164 166 may be overlapped, or may not be overlapped, with each other. In some examples, a section may include more than one object.

Upon identifying sections 164, 166 in video image 162a, matching device 130 may assign one or more classification types 142 to each identified section. For example, if section 164 includes an image of a cat, matching device 130 may assign classification types such as “animal”, “pet”, “cat”, to section 164. In another example, if section 166 includes an image of an apple, matching device 130 may assign classification types such as “fruit”, “food”, to section 166. Memory 132 may store a classification type list 126 that may include a plurality of defined classification types, such that matching device 130 may access classification type list 126 to identify one or more appropriate classification types for each section. Memory 132 may further include a database 127, there database 127 may indicate the assignment of classification types to each section of each set of video images of each video data. In some examples, assignment of a section to one or more classification types may be performed manually by a user of system 100, or automatically by various object classification or categorization algorithms that may be a part of matching instruction 124.

Matching device 130 may determine a timeframe for each section, where each timeframe may indicate a start time and end time in which a corresponding section may be present. For example, a timeframe 144 of section 164 may indicate a start time and an end time in which section 164 is present in one or more video images 162. Matching device 130 may also determine a location 146 of each section within video image 162a. Location 146 of a section may be represented as coordinates, grid numbers, etc.

Matching device 130 may generate section data 140 for each section by combining classification types 142, timeframe 144, and location 146. Matching device 130 may send section data 140 to first content provider 150 through processor 120.

Matching device 130 may further send classification type list 126 to second content provider 180. Second content provider 180 may identify one or more classification types defined in classification type list 126, and may send content 182 and the identified classification types (further described below) to matching device 130. Content 182 may include, but not limited to, at least one of an advertisement, a hyperlink, an image, a message, an article, a video, one or more pieces of information, etc. In an example, content 182 may include an advertisement promoting a product and/or service of a entity, such as a company associated with second content provider 182. In an example, content 182 may include one or more hyperlinks to informative information, such as a link to a web page. In an example, content 182 may include one or more hyperlinks to a web page to purchase an object associated with sections among video data 160. In an example, content 182 may include hyperlink to another video stored in first content provider 150. Matching device 130 may update database 127 based on the received content and classification types, such that database 127 may indicate correspondences among sections of video images, classification types, and one or more pieces of content. Matching device 130 may send content 182 to first content provider 150 through processor 120.

First content provider 150 may output video data 160 such that a user 101 may view, via a user interface device (not shown), a video rendered from video data 160. For example, first content provider 150 may stream (e.g., push) video content to one or more user devices. During the output of video data 160, user 101 may interact, via a user interface device (not shown), with one or more sections of video images 162 of video data 160. For example, during the output of video image 162a of video data 160, user 101 may interact, via a user interface device that may be controlled by user 101 (not shown), with section 164 of video image 162a, such as by using a computer mouse to click on an object (e.g., a cat) in section 164. In response to the interaction, matching device 130 may identify a piece of content based on the correspondences indicated by database 127. For example, content 182 may be an advertisement for cat food, such that content 182 may be assigned to classification type of “cat”. Matching device 130 may identify that section 164 is assigned to classification type of “cat”, and may identify content 182 that is also assigned to “cat”. Matching device 130 may insert content 182 in video data 160, such that content 182 may be outputted to user 101 during output of video data 160. In some examples, processor 120 may suspend the output of video data 160 in response to detection of an interaction and may output content 182. In some examples, video data 160 may include one or more break points, such that content 182 may be inserted into a next available break point during output of video data 160. For example, a break point may be located at “3 minutes 30 seconds” of the video being outputted. If an interaction is detected at “3 minutes”, content 182 may be inserted into the break point at “3 minutes 30 seconds” of the video such that content 182 may be outputted subsequent to the detected interaction.

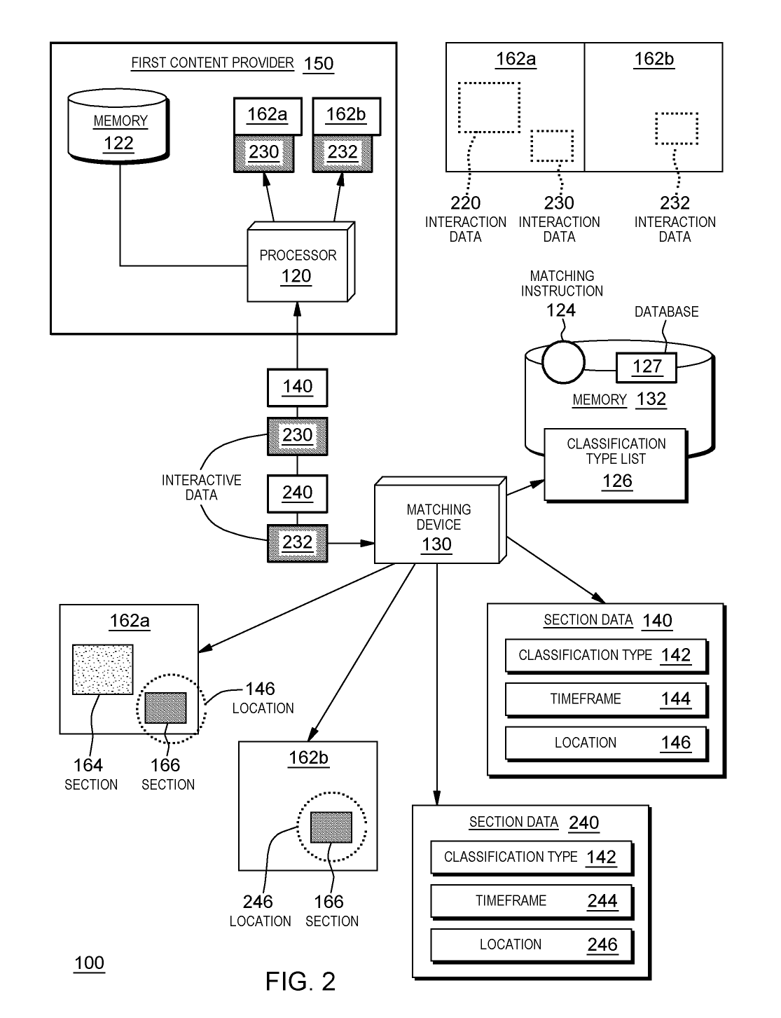

FIG. 2 illustrates the example system of FIG. 1 with additional details relating to content presentation based on video interaction, arranged in accordance with at least some embodiments described herein. FIG. 2 is substantially similar to computer system 100 of FIG. 1, with additional details. Those components in FIG. 2 that are labeled identically to components of FIG. 1 will not be described again for the purposes of clarity.

In some examples, a section of a video image may be present in two or more video images within a video. For example, an apple may be present in more than one consecutive frames of a video. In an example shown in FIG. 2, matching device 130 may identify an object in section 166 in video images 162a, 162b of video data 160 in order to determine that section 166 is present in more than one video images. A section that is present in more than one video image may remain in a same location, or may be located in different locations. For example, in the example shown in FIG. 2, section 166 may be located at location 146 in video image 162a, and may be located at a location 246 in video image 162b. Further, a section may be located at a first location in a first timeframe and may be located at a second location in a second timeframe. For example, section 166 may be located at location 146 during timeframe 144, and may be located at location 246 during timeframe 244.

Matching device 130 may analyze each video image and may generate section data for one or more video images. Each piece of section data may correspond to a section identified by matching device 130. In an example, a particular section may be present in a timeframe from “1 minute 30 seconds” to “1 minute 40 seconds” of a video. The particular section may be located at a first location from “1 minute 30 seconds to” to “1 minute 34 seconds”, and may be located at a second location from “1 minute 35 seconds” to “1 minute 40 seconds”. Matching device 130 may generate first section data to indicate a classification type of the particular section, the first location, and timeframe starting from “1 minute 30 seconds” to “1 minute 34 seconds”. Matching device 130 may further generate second section data to indicate the classification type of the particular section, the second location, and timeframe starting from “1 minute 35 seconds” to “1 minute 40 seconds”.

In the example shown in FIG. 2, matching device 130 may generate section data 140 corresponding to section 166, where section data 140 may indicate that section 166 is assigned to classification type 142, is present in timeframe 144, and is located at location 146 within timeframe 144. Matching device 130 may further generate section data 240 corresponding to section 166, where section data 240 may indicate that section 166 is assigned to classification type 142, is present in timeframe 244 and is located at location 246 within timeframe 244. Matching device 130 may generate further section data associated with section 166 that may correspond to locations at different timeframes. Matching device 130 may send section data 140, 240 to processor 120.

Matching device 130 may further generate interaction data 230, 232, for one or more video images of video data 160 based on section data 140, 240, respectively. In some examples, each interaction data 230, 232, when rendered, may output a visible indicator to highlight a corresponding section during output of video data 160. Visible indicators may include outputting an outline of an object within the section, outputting a message with a pointer pointing at an object within the section, flashing a highlight portion of the section, etc. In some examples, each interaction data 230, 232, when rendered, may be invisible to users viewing video data 160. Generation of interaction data 230 may include identifying timeframe 144 in section data 140, and in response, may identify one or more video images among 160 that may be within timeframe 144.

In some examples, matching device 130 may send section data 140, 240 to processor 120. Processor 120 may generate interaction data 230, 232, based on the received section data 140, 240.

In examples where matching device 130 generates interaction data 230, 232, matching device 130 may send interaction data 230, 232 to processor 120 along with section data 140, 240.

Processor 120 may be configured to append interaction data 230 to location 146 within video image 162a, such that during an output of video data 160, interaction data 230 may be outputted at location 146 within video image 162a during timeframe 144. Similarly, processor 120 may append interaction data 232 to location 246 within video image 162b, such that during an output of video data 160, interaction data 232 may be outputted at location 246 within video image 162b during timeframe 244.

First content provider 150 may output video data 160, where outputting video data may 160 may include outputting video images 162a, 162b. As a result of appending interaction data 230, 232, to video images 162a, 162b, interaction data 230 may be outputted during an output of video image 162a and interaction data 232 may be outputted during an output of video image 162b. In some examples, first content provider 150 may output more than one pieces of interaction data during output of a video image. For example, processor 120 may output interaction data 220 associated with section 164, and interaction data 230, during output of video image 162a.

During output of video data 160, user 101 may view a video being outputted as a result of outputting video data 160, and may be interact with the video. For example, during an output of video image 162a, user 101 may view sections 164, 166, and may interact with one or more sections such as by using a computer mouse to click on a section, hovering a cursor over a section, etc. As will be described in more detail below, interaction performed by user 101 may cause processor 120 to identify content to be outputted during an output of video data 160.

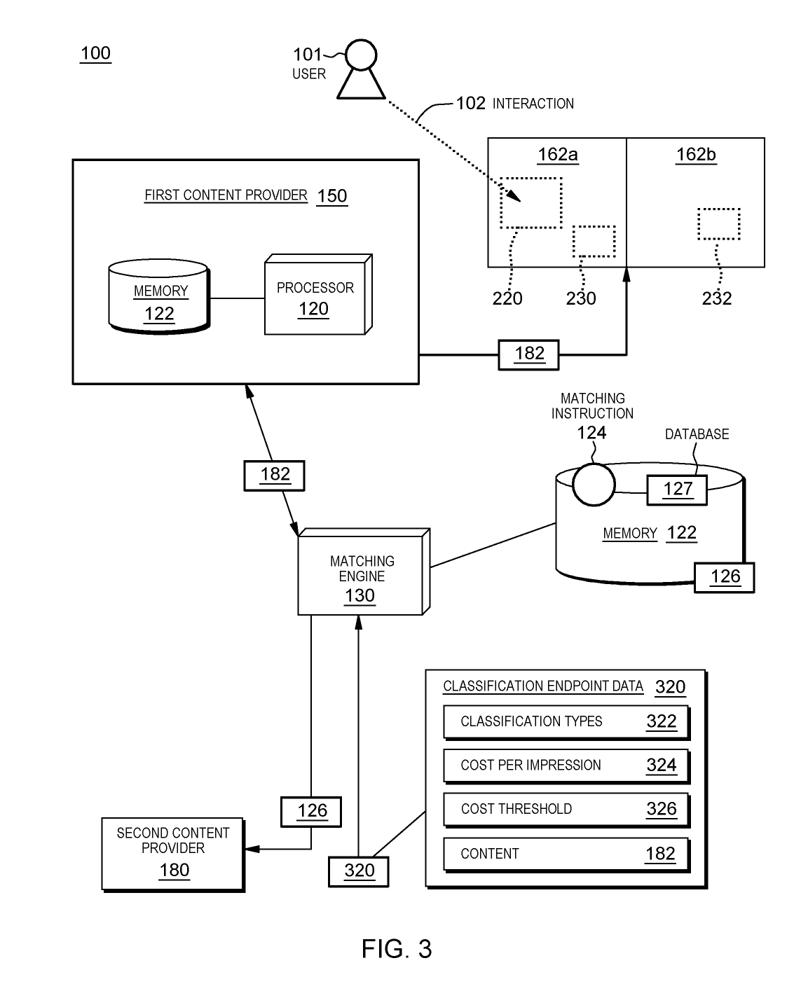

FIG. 3 illustrates the example system of FIG. 1 with additional details relating to content presentation based on video interaction, arranged in accordance with at least some embodiments described herein. FIG. 3 is substantially similar to computer system 100 of FIG. 1 and FIG. 2, with additional details. Those components in FIG. 3 that are labeled identically to components of FIG. 1 and FIG. 2 will not be described again for the purposes of clarity.

In an example shown in FIG. 3, matching device 130 may send classification type list to second content provider 180 prior to, or subsequent to, generation of section data associated with video data 160. Second content provider 180 may register for one or more classification types associated with products and/or services of second content provider 180. For example, if promotion content provider 180 is associated with a cat food company, second content provider 180 may register for classification types such as “cat”, “pets”, “animals”, etc. Second content provider 180 may include components such as processors or computer devices configured to generate classification endpoint data 320 that may be used to facilitate registration of classification types.

Classification endpoint data 320 may include a set of classification types 322, a cost per impression 324, a cost threshold 326, and content 182. Classification types 322 may include one or more classifications types which second content provider 180 may wish to register. Cost per impression 322 may include a value to indicate a monetary amount that second content provider 180 may pay first content provider 150 for each instance of content 182 being outputted by first content provider 150. Cost threshold 326 may include a value to indicate a maximum monetary amount that second content provider 180 may pay first content provider 150 for outputting content 182. For example, cost threshold 326 may indicate “$1000” such that when cost per impression is “$0.02”, first content provider 150 may terminate output of content 182 after outputting content 182 for “50,000” times. In some examples, classification endpoint data 320 may further include a data type, or format, of content 182. For example classification endpoint data 320 may indicate that content 182 may be a link to a webpage, a video of mp4 format, etc. In some examples, classification endpoint data 320 may further include a company name of a company associated with second content provider 180.

Second content provider 180 may send classification endpoint data 320 to matching device 130. Matching device 130 may update database 127 to indicate that content 182 is assigned to classification types 322. Matching device 130 may send classification endpoint data 320 to processor 120. Processor 120 may store classification endpoint data 320 in memory 122.

In an example, processor 120 may output video data 160, including video images 162a, 162b. User 101 may view the video being outputted by outputting video data 160. During output of video image 162a, processor 120 may output interaction data 220, 230 that was appended to video image 162a. User 101 may view video image 162a with interaction data 220, 230. In the example shown in FIG. 3, user 101 may perform an interaction 102 with section 164 and/or interaction data 220. Processor 120 may detect interaction 102 and, in response, may send a signal to matching device 130 to indicate that an interaction was detected at section 164 of video image 162a.

Matching device 130 may receive the signal and, in response, may identify classification types 142 assigned to section 164 of video image 162a. Matching device 130 may search for section 164 in database 127 to identify classification types 142. Matching device 130 may further search for a piece of content with at least one of classification types 142 assigned. Matching device 130 may search in database 127 and may identify content 182 is assigned to a classification type among classification types 142. For example, the classification type “cat” may be among classification types 142 assigned to section 164, and may also be among classification types 322 assigned to content 182. Matching device 130 may identify classification type “cat” from a search for section 164 in database 127, then subsequently, may identify content 182 from a search among contents that has classification type “cat” assigned. Matching device 130 may send a signal to processor 120 to indicate that content 182 is identified for section 164.

Processor 120 may receive the signal from matching device 130 and, in response, may retrieve content 182 from memory 122. Processor 120 may insert content 182 into video data 160, such that content 182 may be outputted during an output of video data 160. In some examples, content 182 may be outputted subsequent to an output of the video image associated with the detected interaction (e.g., video image 162a). In some examples, content 182 may be outputted in a pop-up window or a new tab of a browser. In some examples, content 182 may be outputted as a link, message, image, video, etc. overlaying video data 160 during the output of video data 160. An output location and time of content 182 may be based on a format of content 182. For example, if content 182 is an image, processor 120 may output content 182 as a banner within a browser being used to stream video data 160. Matching instruction 124 may include logic that may be used by processor 120 to determine an output location and time of content 182 based on the format of content 182.

In some examples, user 101 may not perform any interaction with the video being outputted by video data 160. Processor 120 may detect the lack of interaction and, in response, may retrieve a random content to be inserted into video data 160 such that the retrieved content may be outputted to user 101 during the output of video data 160, such as by overlaying the outputted video, outputting the content in a pop-up window or a new tab of a browser, or streaming the content in the midst of an output of video data 160. The content selected in response to a lack of interaction may be regardless of any classification type.

In some examples, matching device 130 may identify content 182 based on cost per impression and/or cost threshold of one or more contents that may be stored in memory 122. For example, a first content may have a first cost of impression of “$0.02” and a second content may have a second cost of impression of “$0.15”, where the first and second contents may be assigned with a same classification type. Matching device 130 may compare the first and second costs of impression to determine the greater cost of impression and, in response, may identify the first content in response to the first cost per impression being greater than the second cost per impression. By identifying content of a greater cost of impression, matching device 130 may identify content that may produce relatively greater amount of revenue for first content provider 150.

In another example, a first content may have a cost of impression cost of impression of “$0.02” and a second content may have a cost of impression of “$0.15”, where first and second contents are both assigned with a same classification type. Further, the first and second contents may both have a cost threshold of “1000”. First content provider 150 may have outputted both the first and second content “50,000” times, thus have reached the first cost threshold. Matching device 130 may determine that the first cost threshold has been reached and, in response, may identify the second content to be outputted despite the first cost per impression being greater than the second cost per impression.

In some examples, prior methods may include pre-inserting promotional content into a video by the content provider such that when a user is watching the video, the video is interrupted by the promotional content at one or more times. Other prior methods may include using internet metadata tracking via internet cookies to determine browsing history, or shopping history, of users in order to identify promotional content to be presented to the users. However, utilizing browsing and shopping history to identify preferences of users may be inaccurate as viewing an item online does not necessarily mean a user is interested in that item, or users may no longer be interested in an item that is already purchased. In some examples, content providers may allow a company to be a sponsor and may cause promotional content of the company to be repeated to same users multiple times. As such, the interruptions and promotional content may hinder the user experience if the promotional content is not tailored towards a current interest of the user, and the user may refrain from viewing contents being outputted by the content provider.

A system in accordance with the present disclosure may improve an efficiency of identify appropriate promotional content to users viewing videos on a video streaming service by identifying promotional content based on instantaneous interaction between the users and the content currently being viewed by the users. The system may execute a matching algorithm to match uploaded videos to sponsored content with relatively improved accuracy. The system may analyze audio and still images of an uploaded video frame by frame, and create interactive subsections within that video during those frames. As a result, a user may interact with the video, and content based on what the user may be interested in may be displayed in response to the interaction. For example, a user watching a documentary on nature could click on an animal and be directed towards a book or online reference to learn more about that animal. In another example, a user watching a television show could click on a laptop of a particular brand and be directed towards an advertisement for new items produced by the particular brand or an online store of the particular brand. A system in accordance with the present disclosure may also benefit content providers (e.g., video streaming services) by engaging their consumers with video products, such that number of users of the content provider may increase, and possibilities of securing sponsors to advertise on a platform of the content provider may also be improved.

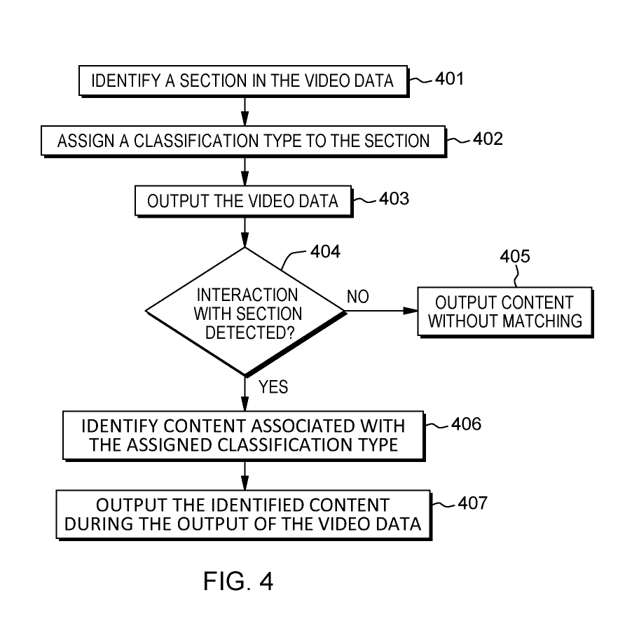

FIG. 4 illustrates a flow diagram for an example process to implement content presentation based on video interaction, arranged in accordance with at least some embodiments presented herein. The process in FIG. 4 could be implemented using, for example, computer system 100 discussed above. An example process may include one or more operations, actions, or functions as illustrated by one or more of blocks 401, 402, 403, 404, 405, 406, and/or 407. Although illustrated as discrete blocks, various blocks may be divided into additional blocks, combined into fewer blocks, eliminated, or performed in parallel, depending on the desired implementation.

Processing may begin at block 401, where a device (e.g., matching device 130 described above) may identify a section in a piece of video data. The section may be located within a video image among a set of video images of the video data.

Processing may continue from block 401 to block 402. At block 402, the device may assign a classification type to the identified section of the video data.

Processing may continue from block 402 to block 403. At block 403, the device may output the video data. Output of the video data may cause an output of a video on a display of a computer device such that a user may be able to view the video. The device may further output interaction data that may be located substantially at a same location as the section during an output of the video image. The interaction data may be appended to the video image prior to an output of the video image.

Processing may continue from block 403 to block 404. At block 404, during the output of the video data, the device may detect whether there are interactions with one or more sections during an output of a video image of the video data. Interactions may be performed by a user viewing the outputted video using a user interface device, such as a computer mouse of a computer. An interaction with the section may include an interaction with the outputted interaction data.

In response to no interaction detected from block 404, at block 405, the device may output a piece of content without matching. The device may randomly select a content provided by any sponsor or promotional content provider.

In response to detecting an interaction with the section from block 404, at block 406, the device may identify content associated with the classification type assigned to the section. The device may first identify the assigned classification type in a database. Then, the device may search among a plurality of contents that are assigned with the identified classification type. The content may be identified as a result of the search, and the search may be based on cost per impression and/or cost threshold associated with the content.

Processing may continue from block 406 to block 407, the device may output the identified content during the output of the video data. The content may be outputted subsequent to the output of the video image, and prior to a next video image among the video data.

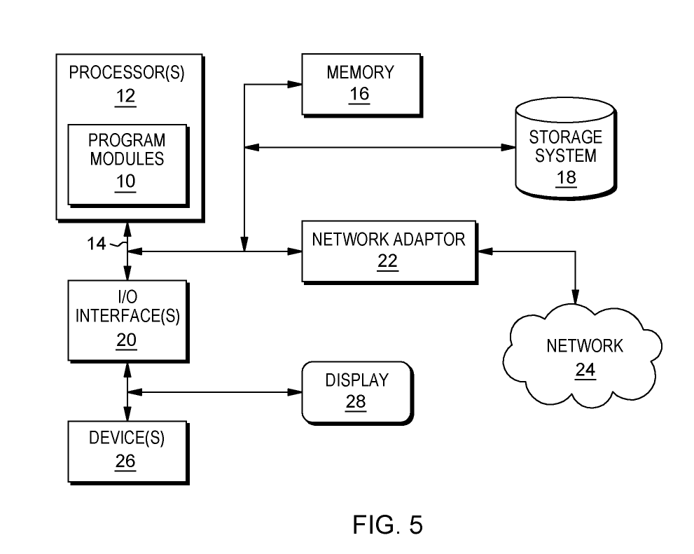

FIG. 5 illustrates a schematic of an example computer or processing system that may implement any portion of computer system 100, processor 120, memory 132, map modules 132, reduce modules 140, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computer system environments or configurations. Examples of well-known computer systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a software module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for identifying content to be outputted during an output of a video, the method comprising:
identifying, by a processor, a section in a video image among a set of video images of the video;
assigning, by the processor, a classification type to the section;
outputting, by the processor, the video, wherein outputting the video includes outputting the set of video images;
detecting, by the processor, an interaction with at least a portion of the section during the output of the video;
identifying, by the processor, in response to detecting the interaction, content associated with the classification type assigned to the section in the video image; and
outputting, by the processor, the identified content during the output of the video.

2. The method of claim 1, further comprising, prior to outputting the video:
determining, by the processor, a timeframe associated with the section, wherein the timeframe indicates a start time and an end time of a presence of the section in the video data;
identifying, by the processor, the video image within the timeframe;
determining, by the processor, a location of the section in the video image;
generating, by the processor, interaction data based on the location; and
appending, by the processor, the interaction data to the video image, wherein outputting the video image includes outputting the interaction data, and wherein detecting the interaction with the section includes detecting an interaction with the interaction data at the location in the video image during output of the video.

3. The method of claim 1, wherein the video image is a first video image, and the section is present in the first video image and in a second video image among the set of video images.

4. The method of claim 1, further comprising, prior to outputting the video:
receiving, by the processor, the content;
receiving, by the processor, a set of classification types assigned to the content; and
storing, by the processor, the assignment of the classification types to the content in a memory.

5. The method of claim 1, further comprising, prior to outputting the video, receiving, by the processor, classification endpoint data that includes the content, a cost per impression, a cost threshold, and a set of classification types assigned to the content, wherein identifying the content is further based on at least one of the cost per impression and the cost threshold.

6. The method of claim 5, wherein the classification endpoint data is first classification endpoint data, the content is a first content, the cost per impression is a first cost per impression, the cost threshold is a first cost threshold, and the set of classification types is a first set of classification types, and the method further comprising:
receiving, by the processor, second classification endpoint data that includes second content, a second cost per impression, a second cost threshold, and a second set of classification types associated with the second content;
comparing, by the processor, the first classification endpoint data with the second classification endpoint data, wherein identifying the content is further based on a result of the comparison of the first classification endpoint data with the second classification endpoint data.

7. The method of claim 6, wherein comparing the first classification endpoint data with the second classification endpoint data includes comparing the first cost per impression with the second cost per impression, and the method further comprising:
determining, by the processor, that the first cost per impression is greater than the second cost per impression; and
identifying, by the processor, in response to the first cost per impression being greater than the second cost per impression, the first content to be outputted during the output of the video.

8. The method of claim 1, wherein the video is a first video, and wherein the content includes at least one of an advertisement, a hyperlink, an image, a message, an article, and a second video.

9. The method of claim 1, wherein the content is a first content, the method further comprising:
detecting, by the processor, a lack of interaction with the section during the output of the video; and
outputting, by the processor, in response to the lack of interaction, a second content different from the first content, wherein the second content is selected by the device regardless of classification type.

10. A system effective to identify content to be outputted during an output of a video, the system comprises:
a memory configured to store video data associated with the video, wherein the video data includes a set of video images;
a processor configured to be in communication with the memory;
a matching device configured to be in communication with the memory and the processor, the matching device is configured to:
identify a section in a video image among a set of video images of the video data; and
assign a classification type to the section;
the processor is configured to:
output the video, wherein output of the video includes output of the set of video images;
detect an interaction with the section during the output of the video;
the matching device is further configured to identify, in response to the interaction, content associated with the classification type assigned to the section in the video image; and
the processor is further configured to output the identified content during the output of the video.

11. The system of claim 10, wherein the matching device is further configured to:
determine a timeframe associated with the section, wherein the timeframe indicates a start time and an end time of a presence of the section in the video data;
identify the video image within the timeframe;
determine a location of the section in the video image;
generate interaction data based on the location; and
append the interaction data to the video image, wherein output of the video image includes output of the interaction data, and wherein detection of the interaction with the section includes detection of an interaction with the interaction data at the location in the video image during output of the video.

12. The system of claim 10, wherein the matching device is further configured to, prior to the output of the video:
receive the content;
receive a set of classification types assigned to the content; and
store the assignment of the classification types to the content in the memory.

13. The system of claim 10, wherein the matching device is further configured to, prior to the output of the video data, receive classification endpoint data that includes the content, a cost per impression, a cost threshold, and a set of classification types assigned to the content, wherein identification of the content is further based on at least one of the cost per impression and the cost threshold.

14. The system of claim 13, wherein the classification endpoint data is first classification endpoint data, the content is a first content, the cost per impression is a first cost per impression, the cost threshold is a first cost threshold, and the set of classification types is a first set of classification types, and the matching device is further configured to:
receive second classification endpoint data that includes second content, a second cost per impression, a second cost threshold, and a second set of classification types associated with the second content;
compare the first classification endpoint data with the second classification endpoint data, wherein identifying the content is further based on a result of the comparison of the first classification endpoint data with the second classification endpoint data.

15. The system of claim 14, wherein comparison of the first classification endpoint data with the second classification endpoint data includes comparison of the first cost per impression with the second cost per impression, and the matching device is further configured to:
determine that the first cost per impression is greater than the second cost per impression; and
identify, in response to the first cost per impression being greater than the second cost per impression, the first content to be outputted during the output of the video.

16. The system of claim 10, wherein the video is a first video, and wherein the content includes at least one of an advertisement, a hyperlink, an image, a message, an article, and a second video.

17. A computer program product for identifying content to be outputted during an output of a video, the computer program product comprising a computer readable storage medium having program instructions embodied therewith, the program instructions executable by a device to cause the device to:
identify a section in a video image among a set of video images of the video;
assign a classification type to the section;
output the video, wherein output of the video includes output of the set of video images;
detect an interaction with the section during the output of the video;
identify, in response to detecting the interaction, content associated with the classification type assigned to the section in the video image; and
output the identified content during the output of the video data.

18. The computer program product of claim 17, wherein the program instructions are further executable by the device to cause the device to:
determine a timeframe associated with the section, wherein the timeframe indicates a start time and an end time of a presence of the section in the video data;
identify the video image within the timeframe;
determine a location of the section in the video image;
generate interaction data based on the location; and
append the interaction data to the video image, wherein outputting the video image includes outputting the interaction data, and wherein detecting the interaction with the section includes detecting an interaction with the interaction data at the location in the video image during output of the video.

19. The computer program product of claim 17, wherein the program instructions are further executable by the device to cause the device to:
receive classification endpoint data that includes the content, a cost per impression, a cost threshold, and a set of classification types assigned to the content; and
store the assignment of the classification types to the content in a memory, wherein identification of the content is further based on at least one of the cost per impression and the cost threshold.

20. The computer program product of claim 17, wherein the video is a first video, and wherein the content includes at least one of an advertisement, a hyperlink, an image, a message, an article, and a second video.
